(19) United States
(12) Patent Application Publication
(10) Pub. No.: US 2009/0303665 A1
(43) Pub. Date: Dec. 10, 2009

(54) SOLID ELECTROLYTIC CAPACITOR AND METHOD FOR PRODUCING SAME

(75) Inventor: Hideki Oohata, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Minato-ku, Tokyo (JP)

(21) Appl. No.: 12/159,523

(22) PCT Filed: Dec. 27, 2006
(86) PCT No.: PCT/JP2006/326066

§ 371 Date: May 5, 2009

Related U.S. Application Data
(60) Provisional application No. 60/755,797, filed on Jan. 4, 2006.

(30) Foreign Application Priority Data
Dec. 27, 2005 (JP) 2005-376641

(51) Int. Cl. H01G 9/02; H01G 9/00

(52) U.S. Cl. 361/527; 361/525; 29/25.03

(57) ABSTRACT

A solid electrolytic capacitor comprising a solid electrolyte comprised of an electroconductive polymer, formed on a metal substrate with a valve action having a dielectric film formed on the surface thereof, characterized in that the dielectric film has a thickness of at least 30 nm, and the solid electrolyte contains 0.1% to 20% by mol, based on the total monomer units constituting the electroconductive polymer, of an anion of an aromatic compound, preferably an aromatic polycyclic compound having an aromatic polycyclic structure as basic skeleton and containing a Brφnsted acid group, as a dopant.

### CROSS-REFERENCE TO RELATED APPLICATION

This application is an application filed under 35 U.S.C. §111(a) claiming benefit pursuant to 35 U.S.C. §119(e) (1) of the filing date of Provisional Application No. 60/755,797 filed Jan. 4, 2006, pursuant to 35 U.S.C §111(b).

### TECHNICAL FIELD

This invention relates to a solid electrolytic capacitor comprising a solid electrolyte comprised of an electroconductive polymer, formed on a metal substrate with a valve action having a dielectric film formed on the surface thereof, and a process for producing the capacitor.

### BACKGROUND ART

To cope with the demands for digitization of electrical appliances and higher speed processing of personal computers in recent years, the capacitors used therefor are required to be compact, have a large capacitance and give a low impedance in a high frequency region. These capacitors have been recently used for vehicles, and are further required to have a more enhanced withstand voltage.

A fundamental element (6) of a solid electrolytic capacitor generally has a structure as illustrated in FIG. 1, wherein an oxide film layer (2) comprised of a dielectric is formed on an anode substrate (1) comprised of an etched metal foil having a large specific surface area; a solid semiconductor layer (hereinafter referred to as “a solid electrolyte” when appropriate) (3) is formed on the oxide film layer as confronting electrodes, and preferably an electroconductive layer (4) made from an electroconductive paste is formed on the solid electrolyte. An anode region comprising the anode substrate (1) and a cathode region comprising the solid electrolyte (3) and the electroconductive layer (4) are separated preferably by a masking material (5). The above-mentioned fundamental element (6) is used either singly or as a combination of stacked plural layers of the fundamental elements as illustrated in FIG. 2, for a capacitor. Leads (7) and (8) are connected to the anode region and the cathode region, respectively. An entire assembly of the fundamental elements (6), and the leads (7) and (8) is completely encapsulated with a material such as an epoxy resin (9), and widely used as a capacitor for various electrical articles.

Various processes for forming a solid electrolyte have hitherto been proposed, which include, for example, a process wherein a solid electrolyte layer is formed from a melt of the solid electrolyte on a metal substrate with a valve action having a surface layer which is full of pores or voids; and a process wherein a solid electrolyte comprised of an electroconductive polymer composition is formed on a dielectric layer by polymerizing an electroconductive polymer-forming monomer on the dielectric layer. As specific examples of the latter process for forming a solid electrolyte, there can be mentioned a process wherein a hetero-five-membered ring compound such as pyrrole or thiophene is polymerized to form an electroconductive polymer, by a procedure wherein an anode foil is dipped in an aqueous lower alcohol solution of a hetero-five-membered ring compound, and then dipped in an aqueous solution containing an oxidizing agent and an electrolyte, thereby allowing the hetero-five-membered ring compound to chemical polymerization to form an electroconductive polymer; and, a process wherein an oxide film surface layer of a metal substrate foil is coated with a 3,4-ethylenedioxythiophene monomer and an oxidizing agent, which are preferably in a solution form, at once or one after the other, followed by polymerization for forming an electroconductive polymer.

As processes for enhancing the withstand voltage of a capacitor, some proposals have been made, which include, for example, a process wherein a capacitor element having formed therein an electroconductive polymer is heat-treated at a temperature lower than 200° C. before aging, thereby improving the leakage current-reducing characteristics (Japanese Unexamined Patent Publication (JP-A) 2003-17369); and a process wherein a capacitor element comprising a winding of an anode foil and a cathode foil is coated with a silane compound or dipped with a solution of a silane compound, the anode foil is again subjected to a chemical formation, and then an electroconductive polymer is formed within the capacitor element (JP-A 2005-183564).

However, in the case when the electroconductive polymer such as polypyrrole is formed as a solid electrolyte on the surface of a dielectric by an electrolytic polymerization or a chemical polymerization, problems arise in that the uniformity of a resulting electroconductive polymer film, the soldering heat resistance, the impedance characteristics and the withstand voltage. The yield at an aging step is also required to improve.

Thus, qualities, especially high withstand voltage are still eagerly desired for the above-proposed processes including the process heat-treating a capacitor element having formed therein an electroconductive polymer at a temperature of lower than 200° C. before aging, thereby improving the leakage current reducing characteristics; and the process coating a capacitor element comprising a winding of an anode foil and a cathode foil with a silane compound or dipping the capacitor element with a solution of a silane compound, again subjecting the anode film to a formation, and then forming an electroconductive polymer within the capacitor element.

### DISCLOSURE OF THE INVENTION

### Problems to Be Solved by the Invention

Objects of the present invention are to provide a solid electrolytic capacitor exhibiting an effectively reduced leakage current and an enhanced withstand voltage; and to provide a process for producing the solid electrolytic capacitor with an enhanced efficiency.

### Means for Solving the Problems

The present inventors made extensive researches to solve the above-mentioned problems, and have found that a solid electrolytic capacitor exhibiting a reduced leakage current and an enhanced withstand voltage can be obtained by conducting the polymerization for forming a solid electrolyte comprised of an electroconductive polymer, on a dielectric film having a thickness of at least 30 nm, and by incorporating a certain amount of an anion of an aromatic compound as a dopant in the solid electrolyte. Based on this finding, the present invention has been completed.

Thus, in accordance with the present invention, there are provided the following solid electrolytic capacitors and the following processes for producing the capacitors.

(1) A solid electrolytic capacitor comprising a solid electrolyte comprised of an electroconductive polymer, formed on a metal substrate with a valve action having a dielectric film formed on the surface thereof, characterized in that said dielectric film has a thickness of at least 30 nm and said solid electrolyte contains 0.1% to 20% by mol, based on the total monomer units constituting the electroconductive polymer, of an anion of an aromatic compound as a dopant.

(2) The solid electrolytic capacitor as described above in (1), wherein the solid electrolyte has an electrical conductivity in the range of 0.01 S/cm to 10 S/cm.

(3) The solid electrolytic capacitor as described above in (1) or (2), wherein the aromatic compound has an aromatic ring structure as basic skeleton selected from p-benzoquinone, o-benzoquinone, 1,2-naphthoquinone, 1,4-naphthoquinone, 2,6-naphthoquinone, 9,10-anthraquinone, 1,4-anthraquinone, 1,2-anthraquinone, 1,4-chrysenequinone, 5,6-chrysenequinone, 6,12-chrysenequinone, acenaphthoquinone, acenaphthenequinone, camphorquinone, 2,3-bornanedion, 9,10-phenanthrenequinone and 2,7-pyrenequinone, and the aromatic compound contains a Brφnsted acid group.

(4) The solid electrolytic capacitor as described above in (1) or (2), wherein the aromatic compound has an anthraquinone skeleton, a 1,4-naphthoquinone skeleton or a 2,6-naphthoquinone skeleton, and contains a sulfonic acid group or a carboxylic acid group as the Brφnsted acid group.

(5) The solid electrolytic capacitor as described above in any one of (1) to (4), wherein the electroconductive polymer constituting the solid electrolyte is a polymer represented by the following general formula [1]:

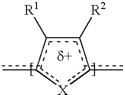

wherein substituents R¹ and R² each independently represent a monovalent group selected from the group consisting of a hydrogen atom, a straight-chain or branched, saturated or unsaturated hydrocarbon group having 1 to 6 carbon atoms, a straight-chain or branched, saturated or unsaturated alkoxy group having 1 to 6 carbon atoms, a hydroxyl group, a halogen atom, a nitro group, a cyano group, a straight-chain or branched perfluoroalkyl group having 1 to 6 carbon atoms, a phenyl group and a substituted phenyl group, wherein R¹ and R² may combine with each other at any position to form at least one divalent chain for forming at least one 5-, 6- or 7-membered ring saturated or unsaturated cyclic structure; X represents a hetero atom selected from the group consisting of S, O, Se, Te and NR³ where R³ represents a hydrogen atom, a straight-chain or branched, saturated or unsaturated hydrocarbon group having 1 to 6 carbon atoms, or a straight-chain or branched, saturated or unsaturated alkoxy group having 1 to 6 carbon atoms; and wherein the hydrocarbon group and the alkoxy group, represented by R¹, R² and R³, may optionally have in the chain thereof a carbonyl bond, an ether bond, an ester bond, an amide bond or an imino bond; δ represents a number in the range of from 0 to 1; and the dashed lines refer to the state in which the electroconductive polymer is doped.

(6) The solid electrolytic capacitor as described above in any one of (1) to (4), wherein the electroconductive polymer constituting the solid electrolyte is a polymer represented by the following general formula [2]:

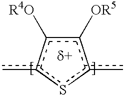

wherein substituents R⁴ and R⁵ each independently represent a hydrogen atom, a straight-chain or branched, saturated or unsaturated hydrocarbon group having 1 to 6 carbon atoms, wherein R⁴ and R⁵ as the hydrocarbon group having 1 to 6 carbon atoms may combine with each other at any position to form at least one divalent chain for forming at least one 5-, 6- or 7-membered ring saturated or unsaturated cyclic structure containing the two oxygen atoms shown in the formula [2], said cyclic structure containing a chemical structure selected from the group consisting of a substituted vinylene group and a substituted o-phenylene group; δ represents a number in the range of from 0 to 1; and the dashed lines refer to the state in which the electroconductive polymer is doped.

(7) A process for producing a solid electrolytic capacitor comprising:

at least one cycle comprising steps of coating a metal substrate having a valve action, having a dielectric film, formed on the surface of the substrate, with a solution containing an electroconductive polymer-forming monomer, and then drying the thus-formed liquid coating, and

at least one cycle comprising steps of coating the metal substrate having a valve action, having formed thereon the dielectric film, with a solution containing an oxidizing agent, and then drying the thus-formed coating of the oxidizing agent-containing solution,

whereby said monomer is polymerized to form an electroconductive polymer constituting a solid electrolyte;

characterized in that a metal substrate having formed thereon a dielectric film with a thickness of at least 30 nm is used, and a solution containing an anion of an aromatic compound in addition to the oxidizing agent is used as the oxidizing agent-containing solution, to form an electroconductive polymer containing 0.1% to 20% by mol, based on the total monomer units constituting the electroconductive polymer, of the anion of the aromatic compound as a dopant.

(8) The process for producing a solid electrolytic capacitor as described above in (7), wherein the aromatic compound has an aromatic ring structure as basic skeleton selected from p-benzoquinone, o-benzoquinone, 1,2-naphthoquinone, 1,4-naphthoquinone, 2,6-naphthoquinone, 9,10-anthraquinone, 1,4-anthraquinone, 1,2-anthraquinone, 1,4-chrysenequinone, 5,6-chrysenequinone, 6,12-chrysenequinone, acenaphthoquinone, acenaphthenequinone, camphorquinone, 2,3-bornanedion, 9,10-phenanthrenequinone and 2,7-pyrenequinone, and the aromatic compound contains a Brφnsted acid group.

(9) The process for producing a solid electrolytic capacitor as described above in (7), wherein the aromatic compound has an anthraquinone skeleton, a 1,4-naphthoquinone skeleton or a 2,6-naphthoquinone skeleton, and contains a sulfonic acid group or a carboxylic acid group.

(10) The process for producing a solid electrolytic capacitor as described above in any one of (7) to (9), wherein the electroconductive polymer-forming monomer is a compound represented by the following general formula [3]:

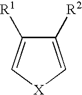

wherein substituents R¹ and R² each independently represent a monovalent group selected from the group consisting of a hydrogen atom, a straight-chain or branched, saturated or unsaturated hydrocarbon group having 1 to 6 carbon atoms, a straight-chain or branched, saturated or unsaturated alkoxy group having 1 to 6 carbon atoms, a hydroxyl group, a halogen atom, a nitro group, a cyano group, a straight-chain or branched perfluoroalkyl group having 1 to 6 carbon atoms, a phenyl group and a substituted phenyl group, wherein R¹ and R² may combine with each other at any position to form at least one divalent chain for forming at least one 5-, 6- or 7-membered ring saturated or unsaturated cyclic structure; X represents a hetero atom selected from the group consisting of S, O, Se, Te and NR³ where R³ represents a hydrogen atom, a straight-chain or branched, saturated or unsaturated hydrocarbon group having 1 to 6 carbon atoms, or a straight-chain or branched, saturated or unsaturated alkoxy group having 1 to 6 carbon atoms; and wherein the hydrocarbon group and the alkoxy group, represented by R¹, R² and R³, may optionally have in the chain thereof a carbonyl bond, an ether bond, an ester bond, an amide bond or an imino bond.

(11) The process for producing a solid electrolytic capacitor as described above in any one of (7) to (9), wherein the electroconductive polymer-forming monomer is a compound represented by the following general formula [4]:

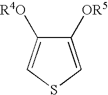

wherein substituents R⁴ and R⁵ each independently represent a hydrogen atom, a straight-chain or branched, saturated or unsaturated hydrocarbon group having 1 to 6 carbon atoms, wherein R⁴ and R⁵ as the hydrocarbon group having 1 to 6 carbon atoms may combine with each other at any position to form at least one divalent chain for forming at least one 5-, 6- or 7-membered ring saturated or unsaturated cyclic structure containing the two oxygen atoms shown in the formula [4], said cyclic structure containing a chemical structure selected from the group consisting of a substituted vinylene group and a substituted o-phenylene group; and δ represents a number in the range of from 0 to 1.

### Effect of the Invention

According to the present invention, a solid electrolytic capacitor exhibiting a reduced leakage current and an enhanced withstand voltage, which can be produced with an enhanced efficiency, is provided.

### BRIEF DESCRIPTION OF THE DRAWINGS

FIG. 1 is a schematic sectional view of a solid electrolytic capacitor element.

FIG. 2 is a schematic sectional view of an assembly comprised of stacked solid electrolytic capacitor elements.

### EXPLANATION OF REFERENCE NUMERALS

1 Anode substrate
2 Oxide film layer
3 Solid electrolyte layer
4 Electroconductive material
5 Masking material
6 Solid electrolytic capacitor
7 Anode lead
8 Cathode lead
9 Encapsulating material

### BEST MODE FOR CARRYING OUT THE INVENTION

The invention will be described in detail.

The solid electrolytic capacitor according to the present invention comprises a solid electrolyte comprised of an electroconductive polymer, formed on a metal substrate with a valve action having a dielectric film formed on the surface thereof.

The metal substrate with a valve action is used as that having a porous layer on the surface thereof. The metal substrate with a valve action having such a porous layer is not particularly limited, provided that it is capable of being used for producing a solid electrolytic capacitor. The metal substrate with a valve action is selected from metals having a valve action such as, for example, those having aluminum, tantalum, niobium, titanium, zirconium and alloys based on at least one of these metals. The metal substrate with a valve action may also be selected from sintered bodies predominantly comprising at least one of these metals and alloys.

The shape of the metal substrate with a valve action is not particularly limited, and includes, for example, a thin sheet or foil, and a rod. A thin sheet and foil are preferable. The metal substrate has a dielectric oxide film formed on the surface thereof by oxidation of the surface layer thereof due to oxygen in the air. However, the metal substrate is usually subjected to a surface-roughening treatment or a chemical formation to form a dielectric oxide film on the surface thereof.

After the surface of the metal substrate with a valve action is roughened, the metal substrate is preferably cut into a desired size and shape conforming to those of the solid electrolytic capacitor.

The size of the metal substrate with a valve action varies depending upon the particular use thereof. For example, when the metal substrate is of a thin-sheet or foil form, those having a thickness in the range of approximately 40 to 150 μm are generally used. The shape of the metal substrate with a valve action also varies depending upon the particular use thereof. For example, when the metal substrate is used for a flat sheet-shape capacitor element, a rectangular sheet having a width in the range of approximately 1 to 50 mm and a length in the range of approximately 1 to 50 mm is preferably used. More preferably the width is in the range of approximately 2 to 20 mm, especially approximately 2 to 5 mm, and the length is in the range of approximately 2 to 20 mm, especially approximately 2 to 6 mm.

In the solid electrolytic capacitor according to the present invention, the metal substrate with a valve action has formed on the surface thereof a dielectric film having a thickness of at least 30 nm. The thickness of the dielectric film is preferably in the range of 30 to 900 nm, more preferably 30 to 500 nm, especially preferably 40 to 500 nm and most preferably 50 to 250 nm. When the thickness is smaller than 30 nm, the leakage current is undesirably large and the sufficiently high withstand voltage cannot be obtained.

The solid electrolytic capacitor of the present invention is characterized in that the electroconductive polymer constituting the solid electrolyte contains 0.1% to 20% by mol, based on the total monomer units constituting the electroconductive polymer, of an anion of an aromatic compound as dopant; and that the dielectric film has a thickness of at least 30 nm. By these characteristics, the leakage current is minimized and the sufficiently high withstand voltage can be obtained.

A preferable electroconductive polymer constituting the solid electrolyte is a polymer represented by the following general formula [1]:

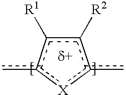

wherein substituents R¹ and R² each independently represent a monovalent group selected from the group consisting of a hydrogen atom, a straight-chain or branched, saturated or unsaturated hydrocarbon group having 1 to 6 carbon atoms, a straight-chain or branched, saturated or unsaturated alkoxy group having 1 to 6 carbon atoms, a hydroxyl group, a halogen atom, a nitro group, a cyano group, a straight-chain or branched perfluoroalkyl group having 1 to 6 carbon atoms, a phenyl group and a substituted phenyl group, wherein R¹ and R² may combine with each other at any position to form at least one divalent chain for forming at least one 5-, 6- or 7-membered ring saturated or unsaturated cyclic structure; X represents a hetero atom selected from the group consisting of S, O, Se, Te and NR³ where R³ represents a hydrogen atom, a straight-chain or branched, saturated or unsaturated hydrocarbon group having 1 to 6 carbon atoms, or a straight-chain or branched, saturated or unsaturated alkoxy group having 1 to 6 carbon atoms; and wherein the hydrocarbon group and the alkoxy group, represented by R¹, R² and R³, may optionally have in the chain thereof a carbonyl bond, an ether bond, an ester bond, an amide bond or an imino bond; δ represents a number in the range of from 0 to 1; and the dashed lines refer to the state in which the electroconductive polymer is doped.

A further preferable electroconductive polymer constituting the solid electrolyte is a polymer represented by the following general formula [2]:

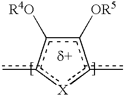

wherein substituents R⁴ and R⁵ each independently represent a hydrogen atom, a straight-chain or branched, saturated or unsaturated hydrocarbon group having 1 to 6 carbon atoms, wherein R⁴ and R⁵ as the hydrocarbon group having 1 to 6 carbon atoms may combine with each other at any position to form at least one divalent chain for forming at least one 5-, 6- or 7-membered ring saturated or unsaturated cyclic structure containing the two oxygen atoms shown in the formula [2], said cyclic structure containing a chemical structure selected from the group consisting of a substituted vinylene group and a substituted o-phenylene group; δ represents a number in the range of from 0 to 1; and the dashed lines refer to the state in which the electroconductive polymer is doped.

A preferable monomer used for forming the electroconductive polymer is a compound represented by the following general formula [3]:

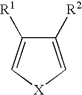

wherein substituents R¹ and R² each independently represent a monovalent group selected from the group consisting of a hydrogen atom, a straight-chain or branched, saturated or unsaturated hydrocarbon group having 1 to 6 carbon atoms, a straight-chain or branched, saturated or unsaturated alkoxy group having 1 to 6 carbon atoms, a hydroxyl group, a halogen atom, a nitro group, a cyano group, a straight-chain or branched perfluoroalkyl group having 1 to 6 carbon atoms, a phenyl group and a substituted phenyl group, wherein R¹ and R² may combine with each other at any position to form at least one divalent chain for forming at least one 5-, 6- or 7-membered ring saturated or unsaturated cyclic structure; X represents a hetero atom selected from the group consisting of S, O, Se, Te and NR³ where R³ represents a hydrogen atom, a straight-chain or branched, saturated or unsaturated hydrocarbon group having 1 to 6 carbon atoms, or a straight-chain or branched, saturated or unsaturated alkoxy group having 1 to 6 carbon atoms; and wherein the hydrocarbon group and the alkoxy group, represented by R¹, R² and R³, may optionally have in the chain thereof a carbonyl bond, an ether bond, an ester bond, an amide bond or an imino bond.

A more preferable monomer used for forming the electroconductive polymer is a compound represented by the following general formula [4]:

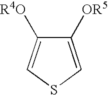

wherein substituents R⁴ and R⁵ each independently represent a hydrogen atom, a straight-chain or branched, saturated or unsaturated hydrocarbon group having 1 to 6 carbon atoms, wherein R⁴ and R⁵ as the hydrocarbon group having 1 to 6 carbon atoms may combine with each other at any position to form at least one divalent chain for forming at least one 5-, 6- or 7-membered ring saturated or unsaturated cyclic structure containing the two oxygen atoms shown in the formula [4], said cyclic structure containing a chemical structure selected from the group consisting of a substituted vinylene group and a substituted o-phenylene group; and δ represents a number in the range of from 0 to 1.

As substituents R¹, R² and R³ in the formulae [1] and [3], preferable examples of the straight-chain or branched, saturated or unsaturated hydrocarbon group having 1 to 6 carbon atoms include methyl, ether, vinyl, propyl, allyl, isopropyl, butyl and 1-butenyl groups. Preferable examples of the straight-chain or branched, saturated or unsaturated alkoxy group having 1 to 6 carbon atoms include methoxy, ethoxy, propoxy, isopropoxy and butoxy groups. Preferable examples of the substituents other than the hydrocarbon group and the alkoxy group include a nitro group, a cyano group, a phenyl group, and substituted phenyl groups such as a halogen-substituted phenyl group including a Cl-, Br- or F-substituted phenyl group. The hydrocarbon group and the alkoxy group, represented by R¹ and R², may optionally have in the chain thereof a carbonyl bond, an ether bond, an ester bond, an amide bond or an imino bond. Preferable examples thereof include a methoxyethoxy group and a methoxyethoxyethoxy group.

The above-mentioned substituents R¹ and R² may combine with each other at any position to form at least one divalent chain for forming at least one 5-, 6- or 7-membered ring saturated or unsaturated cyclic structure. Preferable examples of the divalent chain for forming the cyclic structure include a 3,4-ethylene substituted structure, a 3,4-propylene substituted structure, a 3,4-butenylene substituted structure, a 3,4-butadienylene substituted structure and a naphtho[2,3-c]-condensed structure.

X represents a hetero atom which includes S, O, Se, Te and NR³ where R³ is a group selected from those which are recited for R¹ and R². In the case when X is S, the polymer of the formula [1] wherein R¹ and R² combine with each other to form the above-mentioned 3,4-butadienylene substituted structure, is referred to have an isothianaphthenylene structure; the compound of the formula [3] wherein R¹ and R² combine with each other to form the above-mentioned 3,4-butadienylene substituted structure, is referred to have an isothianaphthene structure; the polymer of the formula [1] wherein R¹ and R² combine with each other to form the above-mentioned naphtho[2,3-c]-condensed structure, is referred to have a naphtho[2,3-c]thienylene structure; and the compound of the formula [3] wherein R¹ and R² combine with each other to form the above-mentioned naphtho[2,3-c]-condensed structure, is referred to have a naphtho[2,3-c]thiophene structure.

δ in the formulae [1] and [2] represents a number of charges for a repeating structural unit and is in the range of from 0 to 1.

As preferable examples of the hydrocarbon group having 1 to 6 carbon atoms for substituents R⁴ and R⁵ in the formulae [2] and [4], there can be mentioned methyl, ether, propyl, isopropyl, vinyl and allyl groups. Further preferable examples of the hydrocarbon group having 1 to 6 carbon atoms for substituents R⁴ and R⁵ are such that the hydrocarbon groups combine with each other at any position to form at least one divalent chain for forming at least one 5-, 6- or 7-membered ring saturated cyclic structure containing the two oxygen atoms shown in the formulae [2] and [4]. Preferable examples of the divalent chain include 1,2-ethylene, 1,2-propylene and 1,2-dimethylethylene. Further examples of the hydrocarbon group having 1 to 6 carbon atoms for substituents R⁴ and R⁵ are such that the hydrocarbon groups combine with each other at any position to form at least one divalent chain for forming at least one 5-, 6- or 7-membered ring unsaturated cyclic structure such as, for example, a substituted vinylene group and a substituted o-phenylene group. Preferable examples of the divalent chain include 1,2-vinylene, 1,2-propenylene, 2,3-butylen-2-ene, 1,2-cyclohexylene, methyl-o-phenylene, 1,2-dimethyl-o-phenylene and ethyl-o-phenylene.

A part of the monomers of the formula [3] used for the preparation of the capacitor of the present invention, such as thiophene (R¹═R²═H, X═S) and pyrrole (R¹═R²═H, X═NH) is known, and, a part of those of the formula [4], such as 3,4-ethylenedioxythiophene, is also known. An oxidizing agent capable of being used for polymerization of these monomers is also known.

In the solid electrolyte used for the capacitor of the present invention, the content of an anion of an aromatic compound is in the range of 0.1 to 20% by mol, preferably 0.5 to 10% by mol, based on the total monomer units constituting the electroconductive polymer.

The solid electrolyte is produced by a process comprising at least one cycle comprising steps of coating a metal substrate having a valve action, having a dielectric film, formed on the surface of the substrate, with a solution containing an electroconductive polymer-forming monomer, and then drying the thus-formed liquid coating; and at least one cycle comprising steps of coating the metal substrate having a valve action, having formed thereon the dielectric film, with a solution containing an oxidizing agent and an anion of an aromatic compound, and then drying the thus-formed coating of the oxidizing agent-containing solution; whereby said monomer is polymerized to form an electroconductive polymer constituting the solid electrolyte. Each of the above-mentioned cycles is carried out at least once, preferably 3 to 30 times.

A preferable example of the above-mentioned process comprises a combination of a cycle comprising steps of coating a metal substrate having a valve action, having a dielectric film, formed on the surface of the substrate, with a solution (solution 1) containing an oxidizing agent and an anion of an aromatic compound and then drying the thus-formed coating, and steps of coating the metal substrate with a solution (solution 2) containing an electroconductive polymer-forming monomer, and then drying the thus-formed liquid coating. The solvents used for the solutions 1 and 2 may be the same or different.

As a procedure for coating the metal substrate with the solution 1 or 2, there can be mentioned a procedure of dipping the metal substrate in each of the solutions 1 and 2; a procedure of spraying each of the solutions 1 and 2 onto the metal substrate; and a procedure of coating the metal substrate with each of the solutions 1 and 2 by, for example, brushing.

By repeating the above-mentioned cycle for the oxidative polymerization, a solid electrolyte having a high soldering heat resistance can easily be obtained. This makes a marked contrast with a conventional capacitor provided with a solid electrolyte comprised of polypyrrole. Thus, the capacitor of the present invention, provided with the above-mentioned solid electrolyte, has excellent heat stability and exhibits good stability of doped state. This is because the polymer composition containing the above-mentioned dopant can be deposited gradually to a sufficient extent inside the micropores of the metal substrate as well as on the surface of dielectric film, and the electroconductive polymer forms a multilayer structure comprised of a plurality of superposed thin polymer films. By this multilayer structure, the dielectric film is not damaged and exhibits excellent heat stability.

The anion of an aromatic compound used in the present invention has a molecular radius as an ion, which is far larger than that of conventionally used anions such as ClO₄⁻, BF₄⁻, Cl⁻ and S₄²⁻. Therefore, the doped electroconductive polymer composition has a density capable of manifesting good capacitance characteristics. The doped electroconductive polymer composition can be packed sufficiently inside the dielectric film in the step of forming the above-mentioned solid electrolyte.

Preferable examples of the anion of an aromatic compound used in the present invention are Brφnsted acid groups such as a sulfonic acid group, a carboxylic acid group, a phosphoric acid group and a boric acid group. Of these Brφnsted acid groups, a sulfonic acid group and a carboxylic acid group are preferable. A sulfonic acid group is especially preferable.

The sulfonic acid group-containing compound used in the present invention contains at least one sulfonic acid group which effectively functions as a dopant in the form of a sulfonic acid anion.

The aromatic ring structure as basic skeleton of the aromatic compound includes, for example, p-benzoquinone, o-benzoquinone, 1,2-naphthoquinone, 1,4-naphthoquinone, 2,6-naphthoquinone, 9,10-anthraquinone (hereinafter referred merely to “anthraquinone”), 1,4-anthraquinone, 1,2-anthraquinone, 1,4-chrysenequinone, 5,6-chrysenequinone, 6,12-chrysenequinone, acenaphthoquinone, acenaphthenequinone, camphorquinone, 2,3-bornanedion, 9,10-phenanthrenequinone and 2,7-pyrenequinone. Of these basic skeletons of the aromatic compound, a polycyclic aromatic ring structure is preferable. An anthraquinone skeleton, a 1,4-naphthoquinone skeleton and a 2,6-naphthoquinone skeleton are preferable.

As specific examples of the anthraquinone skeleton of the aromatic compound, there can be mentioned anthraquinone-1-sulfonic acid, anthraquinone-2-sulfonic acid, anthraquinone-1,3-disulfonic acid, anthraquinone-1,4-disulfonic acid, anthraquinone-1,5-disulfonic acid, anthraquinone-1,6-disulfonic acid, anthraquinone-1,7-disulfonic acid, anthraquinone-1,8-disulfonic acid, anthraquinone-2,3-disulfonic acid, anthraquinone-2,6-disulfonic acid, anthraquinone-2,7-disulfonic acid, anthraquinone-1,4,5-trisulfonic acid, anthraquinone-2,3,6,7-tetrasulfonic acid, and alkali metal salts thereof and ammonium salts thereof.

As specific examples of the 1,4-naphthoquinone skeleton of the aromatic compound, there can be mentioned 1,4-naphthoquinone-5-sulfonic acid, 1,4-naphthoquinone-6-sulfonic acid, 1,4-naphthoquinone-5,7-disulfonic acid, 1,4-naphthoquinone-5,8-disulfonic acid, and alkali metal salts thereof and ammonium salts thereof.

As specific examples of the 2,6-naphthoquinone skeleton of the aromatic compound, there can be mentioned 2,6-naphthoquinone-1-sulfonic acid, 2,6-naphthoquinone-3-sulfonic acid, 2,6-naphthoquinone-4-sulfonic acid, 2,6-naphthoquinone-3,7-disulfonic acid, 2,6-naphthoquinone-4,8-disulfonic acid, and alkali metal salts thereof and ammonium salts thereof.

Preferable sulfo-quinones may be selected from commercially available dyes, which include, for example, Anthraquinone Airis R and Anthraquinone Iris RN-3RN. These commercially available dyes are sulfo-quinone dopants having high utility, and are usually used as the above-mentioned salts.

The oxidizing agent used for polymerization of the electroconductive polymer-forming monomer in the present invention is known to be used for oxidative polymerization of pyrrole and thiophene. As specific examples of the oxidizing agent, there can be mentioned those which are described, for example, in JP-A H2-15611, such as iron (III) chloride, Fe(ClO₄)₃, organic acid iron (III) salts, inorganic acid iron (III) salts, alkyl persulfate salts, ammonium persulfate, hydrogen peroxide and K₂Cr₂O₇. Persulfate salts are especially preferable for the polymerization of thiophenes represented by the formula [4].

Preferable conditions for the polymerization will be described below.

The concentrations of the monomers of the formulae [3] and [4], the oxidizing agent and the aromatic compound which are employed in the process for producing the capacitor of the present invention vary depending upon the particular kinds of these monomers and compounds and substituents thereof, and a solvent used, but, the concentrations are usually in the range of 10⁻⁴ to 10 mols/liter, more preferably 10⁻³ to 5 mols/liter.

The polymerization temperature varies depending upon the particular reaction procedures and conditions, but it is usually in the range of −70° C. to 250° C., preferably 0° C. to 150° C., more preferably 10° C. to 100° C., and especially preferably 15° C. to 60° C. When the temperature is too low, the rate of reaction is undesirably low. In contrast, when the temperature is too high, side reactions tend to occur and a resulting electroconductive polymer has poor characteristics.

The humidity of the polymerization atmosphere is preferably in the range of 15 to 45% RH. When the humidity is too low, a liquid coating of the monomer-containing solution and that of the oxidizing agent-containing solution are rapidly dried and the desired degree of polymerization is difficult to obtain. In contrast, when the humidity is too high, the polymerization proceeds, but, the drying rate of a liquid coating of the monomer-containing solution and that of the oxidizing agent-containing solution are too low, and, at the next cycle of dipping in the monomer-containing solution and in the oxidizing agent-containing solution, a polymer in the undried liquid coatings tend to be undesirably dissolved in these solutions.

As specific examples of the solvent used for the monomer-containing solution and the oxidizing agent-containing solution in the production process of the present invention, there can be mentioned aprotic solvents including ethers such as tetrahydrofuran (THF), dioxane and diethyl ether, ketones such as acetone and methyl ethyl ketone, and dimethylformamide, acetonitrile, benzonitrile, N-methylpyrrolidone (NMP) and dimethylsulfoxide (DMSO); esters such as ethyl acetate and butyl acetate; non-aromatic chlorine-containing solvents such as chloroform and methylene chloride; nitro compounds such as nitormethane, nitroethane and nitrobenzene; alcohols such as methanol, ethanol and propanol; organic acids such as formic acid, acetic acid and propionic acid, and anhydrides of these organic acids such as, for example, acetic anhydride; and water. These solvents may be used as a mixed solvent. Preferable solvents are selected from water, alcohols, ketones and mixed solvent of these solvents.

The thus-produced solid electrolyte has a conductivity in the range of 0.01 to 10 S/cm, preferably 0.1 to 8 S/cm and more preferably 0.5 to 5 S/cm.

An electroconductive layer is preferably formed on the thus-produced solid electrolyte by, for example, adhering of an electroconductive paste, plating, deposition of metal or formation of an electroconductive resin film.

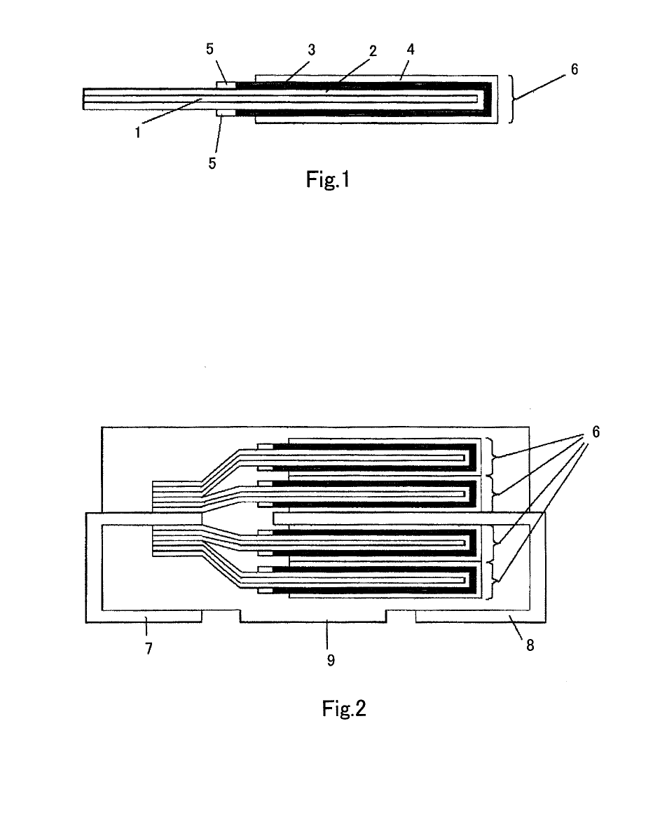

A capacitor is manufactured from a capacitor element prepared by the above-mentioned process of the present invention. For example, a capacitor element having an electroconductive layer (4) as illustrated in FIG. 1 is connected to electrical leads and the thus-obtained assembly is encapsulated with a resin. Another method of manufacturing a capacitor can be adopted wherein a plurality of capacitor elements are stacked together and connected to electrical leads, and the resulting assembly is encapsulated with a resin. For example, as illustrated in FIG. 2, a plurality of capacitor elements (6) are stacked together in a fashion such that a cathode portion (solid electrolyte layer (4)-formed region) of each capacitor element (6) is superposed upon another and an anode portion of each capacitor element (6) is superposed upon another, and electrical leads (8) and (7) are connected to the superposed cathode portions and the superposed anode portions, respectively, and the thus-obtained assembly is encapsulated with a resin (9). A still another method can also be adopted wherein a plurality of capacitor elements each having a cathode portion and an anode portion are stacked together on lead frames corresponding to a cathode and an anode in a fashion such that the cathode and anode of the lead frames correspond to the superposed anode portions and cathode portions of the capacitor elements, respectively, and the thus-obtained assembly is encapsulated with a resin.

The resin used for encapsulating the capacitor element or elements is not particularly limited. For example, an electrically insulating resin such as an epoxy resin can be used.

### EXAMPLES

The present invention will be specifically described by the following working examples. However, these examples are illustrative and should not be construed as limiting the scope of the invention.

### Example 1

A chemically formed aluminum foil with a thickness of 110 μm and having an dielectric layer with a thickness of 50 nm was cut into strips each with a width of 3.5 mm and a length of 13 mm. One end of each strip was fixed to a metal guide by welding. A polyimide solution available from Ube Industries, Ltd. was coated in a linear form with a width of 0.8 mm at a position 7 mm apart from the other end (i.e., an end other than the fixed end), and the linear coating was dried at approximately 180° C. for 30 minutes to form a linear masking.

A portion of the strip spanning from the non-fixed end to the linear masking was subjected to a first chemical forming treatment with an aqueous oxalic solution with a 5% by mass concentration at a current density of 10 mA/cm², a formation voltage of 33 V and a temperature of 25° C. for 2 minutes, and washed with water and then dried.

Thereafter the chemically formed portion was subjected to a second chemical forming treatment with an aqueous sodium silicate solution with a 1% by mass concentration at a current density of 3 mA/cm², a formation voltage of 33 V and a temperature of 65° C. for 7 minutes, and washed with water and then dried. Thereafter the chemically formed strip was heat-treated at 300° C. for 30 minutes.

The chemically formed portion was subjected to a third chemical forming treatment with an aqueous ammonium adipate solution with a 9% by mass concentration at a current density of 3 mA/cm², a formation voltage of 33 V and a temperature of 65° C. for 10 minutes, and washed with water and then dried.

Thereafter a polyimide solution was coated in a linear form with a width of 0.8 mm at a position such that the center line of the 0.8 mm wide line is 5 mm apart from the non-fixed end of the chemically formed strip, and the linear coating was dried at 180° C. for 1 hour to form a border line for dividing the chemically formed strip into an anode portion and a cathode portion.

An solid electrolyte for forming a cathode layer was formed in the cathode portion with a size of 3.5 mm×4.6 mm as follows.

The cathode portion was dipped in a solution (solution 1) of 3,4-ethylenedioxythiophene (monomer) in isopropanol with a concentration of 1 mol/L, pulled up, and then left standing. Then the cathode portion was dipped in an aqueous solution (solution 2) containing 1.5 mol/L of ammonium persulfate (oxidizing agent) and 0.1 mol/L of sodium anthraquinonesulfonate, and then dried to conduct oxidative polymerization. The oxidative polymerization procedure of dipping with solution 1 and then dipping with solution 2 was repeated.

The strip subjected to the oxidative polymerization was left to stand at room temperature for 3 hours, and then dried at 100° C. to form a solid electrolyte layer. Elementary analysis of the solid electrolyte layer by the conventional method revealed that the solid electrolyte layer contained 0.16% by mol of a dopant based on the total monomer. The cathode portion was coated with a carbon paste and then with a silver paste to form an electrode, thus making a capacitor element.

Two capacitor elements were stacked on a lead frame by adhering the portion of the coated polyimide masking material of each capacitor element with a silver paste, and an anode lead terminal was connected by welding to the portions on which the solid electrolyte was not formed. The thus-obtained assembly was encapsulated with an epoxy resin, and was aged at 135° C. while a voltage of 16V was applied. Thus, 30 capacitors in total were manufactured.

Initial characteristics of the 30 capacitors were evaluated as follows. The evaluated characteristics were capacitance at 120 Hz, loss factor (tan δ) at 120 Hz, equivalent series resistance (hereinafter referred to “ESR”) at 100 kHz, and leakage current. The leakage current was measured when 1 minute elapsed after a rated voltage of 12 V was applied. The measurement results were as follows.

| Capacitance (average value): | 19.2 | μF |
|---|---|---|
| Loss factor (tanδ) (average value): | 0.70% | |
| ESR (average value): | 17 | mΩ |
| Leakage current (average value): | 0.13 | μA |

The fraction defective was 5% as evaluated by rating a capacitor exhibiting a leakage current of 1.38 μA (0.005 CV) or larger as a defective.

Further the characteristics were evaluated after a reflow test and subsequently a moisture resistance test were carried out. The reflow test (also referred to as soldering heat resistance test) was conducted as follows. 20 capacitors were provided and the capacitors were passed through a zone maintained at 255° C. over 10 seconds. This reflow operation was repeated 3 times, and thereafter, the leakage current was measured when 1 minute elapsed after the rated voltage was applied. The leakage current of 27.5 μA (0.1 CV) or larger was rated as a defective. The moisture resistance test was conducted as follows. Capacitors were left to stand under high-temperature high-humidity conditions of 60° C. and 90% RH for 500 hours, and then, the leakage current was measured when 1 minute elapsed after the rated voltage was applied. The leakage current of 110 μA (0.4 CV) or larger was rated as a defective. The measurement results were as follows.

Leakage current as measured after reflow test: 6.13 μA

Leakage current as measured after moisture resistance test: 27.1 μA

The fraction defectives as evaluated after the reflow test and after the moisture resistance test were 0%.

### Example 2

By the same procedures as described in Example 1, capacitors were manufactured and evaluated wherein the concentration of sodium anthraquinonesulfonate in solution 2 used for oxidative polymerization for the preparation of solid electrolyte was changed to 0.3 mol/L with all other procedures and conditions remaining the same. Elementary analysis of the solid electrolyte by the conventional method revealed that it contained 0.18% by mol of a dopant based on the total monomer. The results of evaluation of the capacitors are shown in Tables 1 and 2.

### Comparative Example 1

By the same procedures as described in Example 1, capacitors were manufactured and evaluated wherein the concentration of sodium anthraquinonesulfonate in solution 2 used for oxidative polymerization for the preparation of solid electrolyte was changed to 0.01 mol/L with all other procedures and conditions remaining the same. Elementary analysis of the solid electrolyte by the conventional method revealed that it contained 0.09% by mol of a dopant based on the total monomer. The results of evaluation of the capacitors are shown in Tables 1 and 2.

### Comparative Example 2

By the same procedures as described in Example 1, capacitors were manufactured and evaluated wherein the concentration of sodium anthraquinonesulfonate in solution 2 used for oxidative polymerization for the preparation of solid electrolyte was changed to 0.8 mol/L with all other procedures and conditions remaining the same. Elementary analysis of the solid electrolyte by the conventional method revealed that it contained 23% by mol of a dopant based on the total monomer. The results of evaluation of the capacitors are shown in Tables 1 and 2.

### Comparative Example 3

By the same procedures as described in Example 1, capacitors were manufactured and evaluated wherein a chemically formed aluminum foil having an dielectric layer with a thickness of 25 nm was used with all other procedures and conditions remaining the same. Elementary analysis of the resultant solid electrolyte by the conventional method revealed that it contained 0.16% by mol of a dopant based on the total monomer. The results of evaluation of the capacitors are shown in Tables 1 and 2.

TABLE 1
Initial Characteristics of Capacitor

| | Initial characteristics | | | | | |
|---|---|---|---|---|---|---|
| | Capac- | | | Leakage | | No. of |
| | itance | Loss | ESR | current | Defectiive | short- |
| Example | μF | factor % | mΩ | μA | % | circuit *1 |
| Ex. 1 | 19.2 | 0.7 | 17 | 0.13 | 5 | 0 |
| Ex. 2 | 19.5 | 0.8 | 17 | 0.21 | 5 | 0 |
| Com. | 20.0 | 0.75 | 13 | 0.45 | 15 | 0 |
| Ex. 1 | | | | | | |
| Com. | 17.5 | 1.09 | 25 | 0.2 | 25 | 0 |
| Ex. 2 | | | | | | |
| Com. | 19.5 | 3.04 | 20 | 7.4 | 30 | 5 |
| Ex. 3 | | | | | | |

*1 Number of short-circuited capacitors

TABLE 2
Reliability of Capacitor

| | Reflow test | | | Moisture resistance test | | |
|---|---|---|---|---|---|---|
| | Leakage | No. of | No. of | Leakage | No. of | No. of |
| | current | defec- | short- | current | defec- | short- |
| Example | μA | tives | circuit *1 | μA | tives | circuit *1 |
| Ex. 1 | 6.3 | 0 | 0 | 27.1 | 0 | 0 |
| Ex. 2 | 9.4 | 0 | 0 | 43 | 0 | 0 |
| Com. | 24.3 | 2 | 1 | 62.4 | 4 | 3 |
| Ex. 1 | | | | | | |
| Com. | 20.4 | 1 | 1 | 70.3 | 5 | 1 |
| Ex. 2 | | | | | | |
| Com. | 85.3 | 6 | 5 | 105.2 | 9 | 6 |
| Ex. 3 | | | | | | |

*1 Number of short-circuited capacitors

### INDUSTRIAL APPLICABILITY

The solid electrolytic capacitor according to the present invention is characterized as exhibiting a reduced leakage current and an enhanced withstand voltage.

By virtue of these benefits, the solid electrolytic capacitor according to the present invention is widely used as a capacitor provided with a solid electrolyte comprised of an electroconductive polymer, which is suitable, for example, for a capacitor which is compact but has a large capacity, and a capacitor for which a low impedance is required in a high frequency region. The capacitor is especially suitable as a solid electrolytic capacitor for which high withstand voltage is required, such as a capacitor for vehicles.

1. A solid electrolytic capacitor comprising a solid electrolyte comprised of an electroconductive polymer, formed on a metal substrate with a valve action having a dielectric film formed on the surface thereof, characterized in that said dielectric film has a thickness of at least 30 m and said solid electrolyte contains 0.1% to 20% by mol, based on the total monomer units constituting the electroconductive polymer, of an anion of an aromatic compound as dopant.

2. The solid electrolytic capacitor according to claim 1, wherein the solid electrolyte has an electrical conductivity in the range of 0.01 S/cm to 10 S/cm.

3. The solid electrolytic capacitor according to claim 1, wherein the aromatic compound has an aromatic ring structure as basic skeleton selected from p-benzoquinone, o-benzoquinone, 1,2-naphthoquinone, 1,4-naphthoquinone, 2,6-naphthoquinone, 9,10-anthraquinone, 1,4-anthraquinone, 1,2-anthraquinone, 1,4-chrysenequinone, 5,6-chrysenequinone, 6,12-chrysenequinone, acenaphthoquinone, acenaphthenequinone, camphorquinone, 2,3-bornanedion, 9,10-phenanthrenequinone and 2,7-pyrenequinone, and the aromatic compound contains a Brφnsted acid group.

4. The solid electrolytic capacitor according to claim 1, wherein the aromatic compound has an anthraquinone skeleton, a 1,4-naphthoquinone skeleton or a 2,6-naphthoquinone skeleton, and contains a sulfonic acid group or a carboxylic acid group.

5. The solid electrolytic capacitor according to claim 1, wherein the electroconductive polymer constituting the solid electrolyte is a polymer having repeating structural units represented by the following general formula [1]: 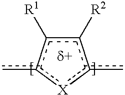
wherein substituents R¹ and R² each independently represent a monovalent group selected from the group consisting of a hydrogen atom, a straight-chain or branched, saturated or unsaturated hydrocarbon group having 1 to 6 carbon atoms, a straight-chain or branched, saturated or unsaturated alkoxy group having 1 to 6 carbon atoms, a hydroxyl group, a halogen atom, a nitro group, a cyano group, a straight-chain or branched perfluoroalkyl group having 1 to 6 carbon atoms, a phenyl group and a substituted phenyl group, wherein R¹ and R² may combine with each other at any position to form at least one divalent chain for forming at least one 5-, 6- or 7-membered ring saturated or unsaturated cyclic structure; X represents a hetero atom selected from the group consisting of S, O, Se, Te and NR³ where R³ represents a hydrogen atom, a straight-chain or branched, saturated or unsaturated hydrocarbon group having 1 to 6 carbon atoms, or a straight-chain or branched, saturated or unsaturated alkoxy group having 1 to 6 carbon atoms; and wherein the hydrocarbon group and the alkoxy group, represented by R¹, R² and R³, may optionally have in the chain thereof a carbonyl bond, an ether bond, an ester bond, an amide bond or an imino bond; δ represents a number in the range of from 0 to 1; and the dashed lines refer to the state in which the electroconductive polymer is doped.

6. The solid electrolytic capacitor according to claim 1, wherein the electroconductive polymer constituting the solid electrolyte is a polymer having repeating structural units represented by the following general formula [2]: 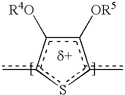
wherein substituents R⁴ and R⁵ each independently represent a hydrogen atom, a straight-chain or branched, saturated or unsaturated hydrocarbon group having 1 to 6 carbon atoms, wherein R⁴ and R⁵ as the hydrocarbon group having 1 to 6 carbon atoms may combine with each other at any position to form at least one divalent chain for forming at least one 5-, 6- or 7-membered ring saturated or unsaturated cyclic structure containing the two oxygen atoms shown in the formula [2], said cyclic structure containing a chemical structure selected from the group consisting of a substituted vinylene group and a substituted o-phenylene group; δ represents a number in the range of from 0 to 1; and the dashed lines refer to the state in which the electroconductive polymer is doped.

7. A process for producing a solid electrolytic capacitor comprising:
at least one cycle comprising steps of coating a metal substrate having a valve action, having a dielectric film, formed on the surface of the substrate, with a solution containing an electroconductive polymer-forming monomer, and then drying the thus-formed liquid coating, and
at least one cycle comprising steps of coating the metal substrate having a valve action, having formed thereon the dielectric film, with a solution containing an oxidizing agent, and then drying the thus-formed coating of the oxidizing agent-containing solution,
whereby said monomer is polymerized to form an electroconductive polymer constituting a solid electrolyte;
characterized in that a metal substrate having formed thereon a dielectric film with a thickness of at least 30 nm is used, and a solution containing an anion of an aromatic compound in addition to the oxidizing agent is used as the oxidizing agent-containing solution, to form an electroconductive polymer containing 0.1% to 20% by mol, based on the total monomer units constituting the electroconductive polymer, of the anion of the aromatic compound as a dopant.

8. The process for producing a solid electrolytic capacitor according to claim 7, wherein the aromatic compound has an aromatic ring structure as basic skeleton selected from p-benzoquinone, o-benzoquinone, 1,2-naphthoquinone, 1,4-naphthoquinone, 2,6-naphthoquinone, 9,10-anthraquinone, 1,4-anthraquinone, 1,2-anthraquinone, 1,4-chrysenequinone, 5,6-chrysenequinone, 6,12-chrysenequinone, acenaphthoquinone, acenaphthenequinone, camphorquinone, 2,3-bornanedion, 9,10-phenanthrenequinone and 2,7-pyrenequinone, and the aromatic compound contains a Brφnsted acid group.

9. The process for producing a solid electrolytic capacitor according to claim 7, wherein the aromatic compound has an anthraquinone skeleton, a 1,4-naphthoquinone skeleton or a 2,6-naphthoquinone skeleton, and contains a sulfonic acid group or a carboxylic acid group.

10. The process for producing a solid electrolytic capacitor according to claim 7, wherein the electroconductive polymer-forming monomer is a compound represented by the following general formula [3]: 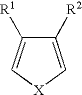
wherein substituents R¹ and R² each independently represent a monovalent group selected from the group consisting of a hydrogen atom, a straight-chain or branched, saturated or unsaturated hydrocarbon group having 1 to 6 carbon atoms, a straight-chain or branched, saturated or unsaturated alkoxy group having 1 to 6 carbon atoms, a hydroxyl group, a halogen atom, a nitro group, a cyano group, a straight-chain or branched perfluoroalkyl group having 1 to 6 carbon atoms, a phenyl group and a substituted phenyl group, wherein R¹ and R² may combine with each other at any position to form at least one divalent chain for forming at least one 5-, 6- or 7-membered ring saturated or unsaturated cyclic structure; X represents a hetero atom selected from the group consisting of S, O, Se, Te and NR³ where R³ represents a hydrogen atom, a straight-chain or branched, saturated or unsaturated hydrocarbon group having 1 to 6 carbon atoms, or a straight-chain or branched, saturated or unsaturated alkoxy group having 1 to 6 carbon atoms; and wherein the hydrocarbon group and the alkoxy group, represented by R¹, R² and R³, may optionally have in the chain thereof a carbonyl bond, an ether bond, an ester bond, an amide bond or an imino bond.

11. The process for producing a solid electrolytic capacitor according to claim 7, wherein the electroconductive polymer-forming monomer is a compound represented by the following general formula [4]: 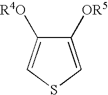
wherein substituents R⁴ and R⁵ each independently represent a hydrogen atom, a straight-chain or branched, saturated or unsaturated hydrocarbon group having 1 to 6 carbon atoms, wherein R⁴ and R⁵ as the hydrocarbon group having 1 to 6 carbon atoms may combine with each other at any position to form at least one divalent chain for forming at least one 5-, 6- or 7-membered ring saturated or unsaturated cyclic structure containing the two oxygen atoms shown in the formula [4], said cyclic structure containing a chemical structure selected from the group consisting of a substituted vinylene group and a substituted o-phenylene group.
